(19) United States
(12) Patent Application Publication
(10) Pub. No.: US 2013/0345004 A1
(43) Pub. Date: Dec. 26, 2013

(54) ACCESSORY DRIVE DECOUPLER

(71) Applicant: Paul T. McCrary, Belleville, MI (US)

(72) Inventor: Paul T. McCrary, Belleville, MI (US)

(73) Assignee: DAYCO IP HOLDINGS, LLC, Springfield, MO (US)

(21) Appl. No.: 13/922,805

(22) Filed: Jun. 20, 2013

Related U.S. Application Data
(60) Provisional application No. 61/661,962, filed on Jun. 20, 2012.

(51) Int. Cl. F16D 15/00

(52) U.S. Cl. CPC F16D 15/00
USPC 474/148; 192/45.1

(57) ABSTRACT

Assemblies for selectively coupling torque between rotating components and belt drive systems including the same are disclosed. The assembly includes a rotatable input member and a rotatable output member operatively connected to one another by a one-way clutch for rotation together in a predominant direction. A spring is included in the assembly with a first end thereof engaged to the one-way clutch and a second end thereof engaged to the rotatable input member. The spring has no preload in an unengaged position of the one-way clutch and rotates with the rotatable input member during a positive torque condition to rotate a component of the one-way clutch to activate the one-way clutch into an engaged position. Then, when the one-way clutch is in the engaged position, the spring radially expands and thereby provides isolation between the rotatable input member and the rotatable output member.

### RELATED APPLICATIONS

This application claims the benefit of U.S. Provisional Application No. 61/661,962, filed Jun. 20, 2012.

### TECHNICAL FIELD

The present application relates generally to pulleys and more particularly to a pulley assembly that includes a decoupling mechanism.

### BACKGROUND

It is known to drive various automobile accessory assemblies, including for example a water pump, an alternator/generator, a fan for cooling coolant, a power steering pump, and a compressor, using the vehicle engine. In particular, a driving pulley actuated by an engine shaft of the motor vehicle drives an endless drive belt that in turn drives the accessory assemblies through driven pulleys.

Periodic torque pulses initiated by, for example, combustion engine firing can create significant speed transitions which can interrupt smooth operation of the driven components. In addition, inertial and driven speed transitions associated with startup, shutdown, jake braking, gear shifting, etc. can also interrupt operation of the driven components. These transitions can result in undesirable effects such as belt jump, belt wear, bearing wear, noise, etc.

The engine, driving belt system, and driven accessory are comprised of primary and additional driving/driven speeds and frequencies. These are characteristic of the system and usually will meet desired operating targets while being relatively stiffly connected by the belt drive system. However at some operating points and/or conditions these speeds and frequencies contribute to unwanted noise, compromise system or component integrity, or contribute to reduced service life of the belt system or individual component. Current solutions provide for overrunning of an accessory and others provide for torsional isolation, but improvements are needed that outperform, last longer, and are more cost effective to manufacture.

In conventional one-way clutches such as sprag and roller clutches, the lock-up function relies upon a wedging action of several small sprags or rollers between an inner and outer race. The precision of this event requires highly accurate machined surfaces be used for each of the components. In addition, this lockup configuration induces a high ratio of radial forces in order to transmit the required tangential force or useful torque. As a result, these clutches must be made from expensive, high quality bearing steel which has been hardened to withstand the forces generated by the wedging action. Additionally, conventional one-way clutches offer limited functionality and greatly reduced load capacity in application with high overrun speeds, high engagement speeds, and vibration, all of which are present to some degree in most automotive environments. These short-comings of the sprag and roller clutches are overcome in the present invention.

### SUMMARY

Improved driven pulley assemblies are disclosed that utilize torque-sensitive coupling and de-coupling to permit one-way relative motion between an input shaft of a driven accessory and an outer driven sheave of the pulley assembly. When the sheave of the pulley assembly is being driven in the predominant direction of rotation, the clutching mechanism of the pulley assembly engages and drives the accessory input shaft for the desired smooth rotation. When relative torque reversals occur as a result of, for example, driven speed transitions, the internal clutching mechanism of the proposed pulley assembly disengages the driven accessory shaft from the outer driven sheave, thereby permitting the driven shaft to continue to rotate with momentum in the predominant direction of rotation.

In one aspect, belt drive assemblies for driving belt driven accessories in an engine of an automotive vehicle are described, and more particularly, to a decoupling mechanism for allowing the belt driven accessories to operate temporarily at a speed other than the belt drive assembly.

In one embodiment, the decoupling mechanism is included in a pulley assembly to provide both overrunning and decoupling capability that exceeds current performance and maintains the level of practicality demanded by the automotive industry. The assembly selectively couples torque between rotating components and includes a rotatable input member and a rotatable output member operatively connected to one another by a one-way clutch for rotation together in a predominant direction. A spring is included in the assembly with a first end thereof engaged to the one-way clutch and a second end thereof engaged to the rotatable input member. The spring has no preload in an unengaged position of the one-way clutch and rotates with the rotatable input member during a positive torque condition to rotate a component of the one-way clutch to activate the one-way clutch into an engaged position. Then, when the one-way clutch is in the engaged position, the spring radially expands and thereby provides isolation between the rotatable input member and the rotatable output member. The assembly also includes a friction ring disposed between the rotatable input member and the rotatable output member to provide coulomb damping. Accordingly, the assembly provides isolation or damping between rotations of the rotatable input member and the rotatable output member at a torsion rate provided by the spring with an amount of coulomb damping provided by the friction ring for improved overall performance.

In one embodiment, a pulley body is the rotatable input member and a hub or hub-shaft assembly is the rotatable output member. The isolation in this configuration may be considered as angular displacement between the pulley body and the hub or hub-shaft at a controlled, torsion rate with an amount of coulomb damping provided by a friction component within the pulley body.

Other advantages and features of the invention will be apparent from the following description of particular embodiments and from the claims.

### BRIEF DESCRIPTION OF THE DRAWINGS

FIG. 1 is a diagrammatic view of an embodiment of an accessory drive system.

FIG. 2 is a perspective side view of an embodiment of an assembled pulley usable in an accessory drive system, for example as illustrated in FIG. 1.

FIG. 3 is a longitudinal cross-section view of the pulley assembly of FIG. 2.

FIG. 4 is an exploded, perspective view of one embodiment of the pulley assembly of FIG. 3.

FIG. 5 is a cross-section view of a portion of the one-way clutch mechanical diode included in the pulley assembly of FIGS. 3 and 4 in an engaged position.

FIG. 6 is a cross-section view of a portion of the one-way clutch mechanical diode in a retracted position.

FIG. 7 is a schematic diagram of the pulley coupled to the input and the output.

FIG. 8 is a longitudinal cross-section view of an alternate embodiment of an assembled pulley usable in an accessory drive system.

FIG. 9 is an exploded, perspective view of the pulley assembly of FIG. 8.

### DETAILED DESCRIPTION

The following detailed description will illustrate the general principles of the invention, examples of which are additionally illustrated in the accompanying drawings. In the drawings, like reference numbers indicate identical or functionally similar elements.

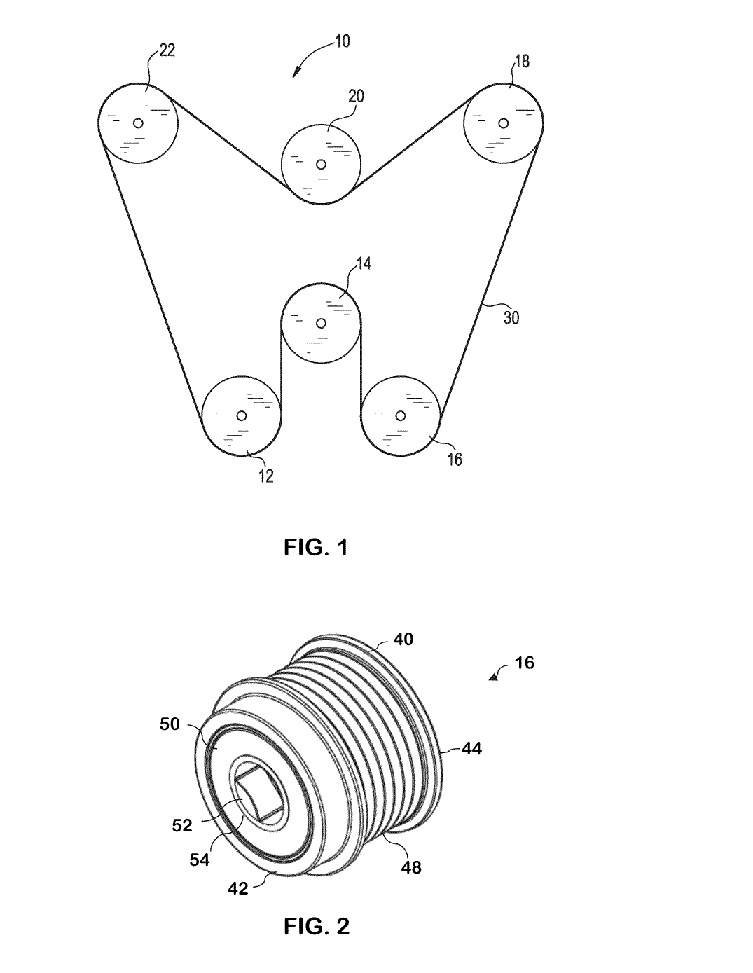

Referring to FIG. 1, an accessory drive system 10 of, for example, an internal combustion engine of an automobile includes an endless belt 30 that is used to drive a number of accessories. The various accessories are represented in FIG. 1 diagrammatically by their pulley assemblies. The belt 30 is entrained around a crank pulley assembly 12, a fan/water pump pulley assembly 14, a power steering pulley assembly 18, an idler pulley assembly 20 and a tensioner pulley assembly 22. In some embodiments, the tensioner pulley assembly 22 includes damping, such as asymmetric damping with a frictional damper to resist lifting of the tensioner arm away from the belt 30.

The various accessories are driven through use of pulley assemblies 14, 16, 18, 20 and 22 that are themselves rotated by the belt 30. For purposes of description, pulley assembly 16 of an alternator will be focused on below. It should be noted, however, that the other pulley assemblies of one or more of the other accessories may also operate in a fashion similar to that of pulley assembly 16.

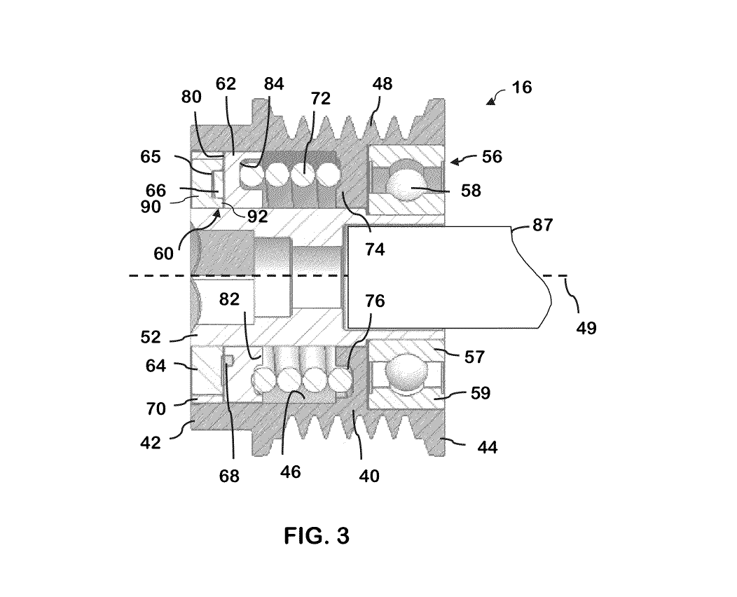

FIG. 2 is a side perspective of pulley assembly 16, which includes a pulley body 40 that has a first end 42 and a second end 44, a bore 46 therein (seen in FIG. 3) and an outer, peripheral belt-engaging surface 48 that engages belt 30 (FIG. 1). The first end 42 of the pulley body 40 is closed by an end cap 50 that receives a first end 54 of a hub-shaft 52 that is housed within the pulley body 40. In the illustrated embodiment, the belt engaging surface 48 is profiled including V-shaped ribs and grooves to mate with corresponding ribs and grooves on the belt 30. Other configurations are possible, such as cogs, flat or rounded ribs and grooves.

Pulley assembly 16 is designed to transfer input torque from the belt 30, through its engagement with the pulley body 40, to an input shaft 87 of an accessory (FIG. 1 and FIG. 3), for example an alternator or fan. The pulley assemblies disclosed herein isolate the input shaft 87 from relative torque reversals through the inclusion of an isolator spring 72. When such relative torque reversals occur, an internal decoupler system of the pulley assembly 16 acts to disengage the input shaft 87 from the torque reversal, also referred to as an overrunning condition, thereby permitting the accessory input shaft 87 to continue rotating with momentum in the predominate operational direction. Still referring to FIG. 3, the hub-shaft 52 may be mated to the input shaft 87 by a Woodruff key, as is well known, to prevent the hub-shaft 52 from freely rotating about the input shaft. Of course other connections between the hub-shaft 52 and the input shaft 87 are also possible including, for example, a splined connection.

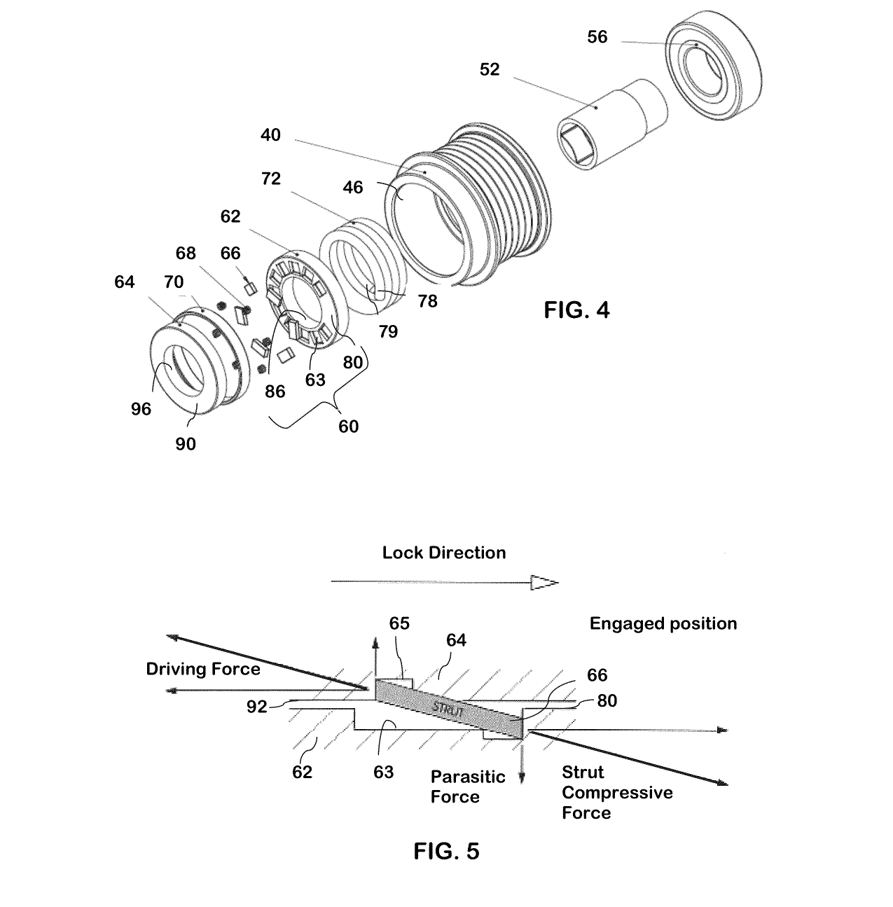

Further details of the pulley assembly 16 are shown in FIGS. 3 and 4. The pulley assembly 16 includes hub-shaft 52, a roller bearing 56, a one-way clutch mechanism 60 (which includes a first plate 62 with pockets 63 therein (to receive struts when in their retracted position), struts 66, a spring 68, and a second plate 64 with notches 65 for strut engagement, a friction ring 70, and an isolator spring 72 that are all housed within a bore 46 of the pulley body 40. The second plate 64 may function as the end cap 50 (shown in FIG. 2) or may be a separate component of the pulley assembly 16. The roller bearing 56 may be located between the hub-shaft 52 and the pulley body 40 proximate the second end 44 of the pulley body 40 to permit stable rotation of the pulley body 40 relative to the hub-shaft 52 when disengaged. The inner race 57 of the roller bearing 56 may be adjacent and coupled to the hub-shaft 52 while the outer race 59 may be adjacent and coupled to the pulley body 40. A roller element 58 is positioned between the inner and outer races 57, 59. The use of a roller bearing may improve the overall structural rigidity of the assembly and extend the life of the assembly by reducing wear as elements of the clutching mechanism rotate relative to one another.

As illustrated in FIG. 3, the hub-shaft 52 is disposed within the bore 46 of the pulley body 40 such that the pulley body can rotate about the hub-shaft. A one-way clutch mechanism 60 is also disposed within the bore 46 in operational engagement with the isolator spring 72. The isolator spring 72 is also in operational engagement with the pulley body 40. In the embodiment, illustrated in FIG. 3, the isolator spring 72 is positioned between the one-way clutch mechanism 60 and the roller bearing 56. The roller bearing 56 may be separated from the isolator spring 72 by a ledge 74 protruding into the central bore 46 of the pulley body 40. The ledge 74 includes a seat 76 for one end of the isolator spring 72.

The isolator spring 72 may be a coil spring or a flat wire spring. In one embodiment, as illustrated in FIGS. 2 and 3, the isolator spring 72 is a coil spring having a first end 78 and a second end 79, in particular is a round wire coil spring. In another embodiment, the coil spring may be a square wire spring.

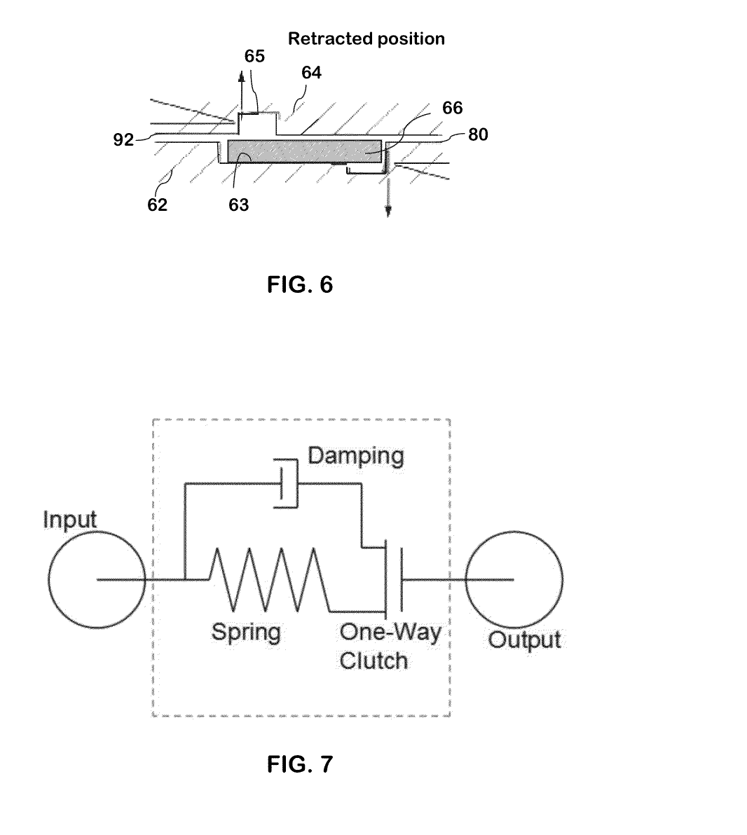

The one-way clutch mechanism 60 (FIGS. 3-6) includes a mechanical diode construction that includes pawl-clutch elements comprising one or more struts 66 and springs 68 between a first plate 62 (lower plate) having pockets 63 therein (to receive struts when in their retracted position, see FIG. 6) and a second plate 64 (upper plate) with notches 65 for strut engagement. “Upper” and “lower” are used herein as relative to positions of the components of the pulley assembly 16 as illustrated in FIG. 3 where, with respect to the orientation of the page, left is upper and right is lower, but in FIGS. 5 and 6 top is upper and bottom is lower.

Still referring to FIGS. 3-6, the first plate 62 has an upper surface 80 comprising one or more pockets 63 recessed therein, a lower surface 82 having a spring seat 84 (FIG. 3) for a first end 78 of the isolator spring 72, and a bore 86 (FIG. 4) for the hub-shaft 52 to pass through. Each pocket 63 is sized to fully receive one strut 66 lying horizontally therein in a retracted position (FIG. 6) and a spring 68 underneath the retracted strut. The spring 68 may be seated in a further recessed receptacle (not shown). The spring 68 is compressed when the strut is in its retracted position. Accordingly, the spring 68 can bias the strut axially away from the pocket 63 and into engagement with a notch 65 in the second plate 64 when aligned therewith (see FIG. 5).

The second plate 64 has a generally smooth upper surface 90, a lower surface 92 comprising one or more notches 65 recessed therein and a bore 96 for receiving the hub-shaft 52. In the assembled state (FIG. 3), the second plate 64 is rotatably fixed to the shaft hub-shaft 52. The second plate 64 has a friction ring 70 surrounding its outer periphery such that the friction ring 70 is between the second plate 64 and an inner surface of the pulley body 40 that defines a portion of the bore 46. The pulley assembly 16 is constructed such that when the one-way clutch is engaged, the second plate 64, which rotates with the hub-shaft 52, will rotate with the other clutch components and hence drive the hub-shaft 52.

The friction ring 70 rubs against the pulley body 40 or the second plate 64 during rotation. This frictional contact provides coulomb damping between the pulley body 40 and the hub-shaft 52, which is shown schematically in FIG. 7. This coulomb damping is generally radially directed as the pulley body and the friction ring press against each other and/or as the second plate 64 and the friction ring press against each other during rotation. The friction generated by the relative motion of these surfaces is a source of energy dissipation. The amount of coulomb damping is controllable and/or adjustable by tailoring various aspects of the interacting components including, but not limited to, the material the components are made from, the surface area of the components that are frictionally engaged, and the presence of a friction-enhancing coating.

As illustrated in FIG. 5, the struts 66 translate axially along the axis of rotation 49 (FIG. 3) as a result of rotational movement of at least a portion of the clutch such as a first plate 62 with pockets 63 for the retracted struts or a second plate 64 with notches 65 for strut engagement. The axial translation is a result of one or more springs 68 acting on each strut 66. The springs 68 bias the struts 66 axially into a notch 65 in the second plate 64 when the first plate 62 is properly aligned with the second plate 64.

In one embodiment, the mechanical diode construction uses rectangular, low-mass struts 66 as seen in FIGS. 4 and 5 that engage precisely in the direction of the torque load. Since the struts 66 are oriented to hold the load more directly, few struts are needed to engage at once. In one embodiment, only one strut engages at a time in most applications, but two or more may engage if desired. This means lower contact loads and virtually no hoop stresses. Accordingly, the clutch includes fewer pieces, can be designed to handle higher loads, can be built out of lower strength materials, and tolerates higher surface variation. The struts 66 have a very high ratio of contact area to mass, yet are slim enough to achieve full engagement with only about 15 degrees of pivot. The struts' low mass, rectangular construction, and lengthwise pivoting axis give them a very low moment of rotational inertia. This—together with the small actuation angle—allows a relatively small spring 68 (best seen in FIG. 4) to almost instantaneously move the strut into locking position. The strut actuation is also insensitive to centrifugal force. During even moderate overrun speeds, the struts “fly” on a layer of oil. The mechanical diode construction's planar strut arrangement and about 15 degree strut engagement angle allow it to transfer force in a more direct fashion—thereby avoiding the trap of using “extreme radial forces to transfer even moderate amounts of torque” which afflicts conventional one-way clutches.

In one embodiment, the mechanical diode construction utilizes more than 93% of the strut's compressive strength to transfer torque. Parasitic (axial) forces are relatively small—especially when compared with friction-actuated one-way clutches, where the contact angle is typically 83 degrees and 99% of the compressive load is directed radially. By contrast, the mechanical diode construction generates lower axial forces, so it's typically smaller and lighter than wedging-action one-way clutches. Instead of sharing enormous radial loads common among many sprag or roller clutches, the mechanical diode construction works by engaging at least one strut 66 at lock-up, a design made possible by its planar transfer of force and the large load-bearing surface offered by each strut. And due to the positive locking nature of its components, the mechanical diode construction suffers no torsional windup. The absence of torsional windup and the low actuation angle discussed above results in excellent engagement resolution, which minimizes engagement impact and prolongs component life.

Another benefit of the mechanical diode construction is that the load-bearing surfaces of the components generally do not come into contact during overrun—any incidental contact is between surfaces which do not mate during engagement. And, even at moderate overrunning speeds, the struts 66 remain in their pockets 63 in the first plate 62 and “fly” on a layer of oil—never coming into contact with the second plate 64. The higher the overrun speed, the more pronounced this effect becomes. This allows the mechanical diode construction to overrun at very high speeds, and affords a long overrun life, longer than the corresponding roller/sprag clutch designs. This ability is due to the oil that the clutch naturally pumps through its internal geometry. This keeps a boundary layer of oil between each of the components and stabilizes the entire system. A secondary effect of the oil utilization is less free-wheel drag and consequently improved transmission efficiency.

The pulley assembly 16, in particular the hub-shaft 52 thereof, defines an axis of rotation 49 as labeled in FIG. 3. When the one-way clutch mechanism 60 is engaged, the pulley body 40 rotates the input shaft 87 of the accessory. The engaged position is achieved by angular displacement provided through the relative rotation of the pulley body 40, the isolator spring 72 and the first plate 62 (as a unit), and then the second plate 64 as explained below. In FIGS. 3 and 4, the second plate 64 is fixed to rotate with the hub-shaft 52. The first ramp plate 62 rotates relative to the second ramp plate 64 until the two plates are aligned as shown in FIG. 5. Once aligned, the strut 66 is moved axially by spring 68 into the notch 65 in the second plate 64 and the two plates 62, 64 rotate together. This is the engaged position of the clutch. In this position, the pulley body 40 through its connection to the first plate 62 is engaged with the hub-shaft 52 through its connection to the second plate 64 such that the pulley body 40 and the hub-shaft 52 rotate in a manner determined by the characteristic of the isolator spring 72, pulley input, and input shaft load.

During an overrunning condition, the input shaft 87 disengages from the pulley assembly 16, in particular from the pulley body 40, and continues to rotate with momentum in the first rotational direction (the predominant direction) when the pulley body 40 experiences a relative torque reversal or sudden slowdown. In this condition, the pulley body 40 may continue to rotate in the first rotational direction but with less angular velocity than the velocity at which it had been driving the input shaft 87. The sudden decrease of angular velocity at the pulley body 40 has the effect of a relative reduction of torque, which displaces the isolator spring 72 towards a lower torque position. If this effect reduces torque to or about zero, then the clutch 60 is relieved of the forces that moved it into an engaged position. As the contact pressure decreases, clutch 60 will eventually disengage, which uncouples the pulley body 40 from the hub-shaft 52 so that they can rotate relative to one another with friction as determined by friction ring 70 such that the input shaft 87 rotates independently of the pulley body 40.

In this overrun condiction, the hub-shaft 52 (output) is free to rotate at speeds greater than the pulley body 40 (input) as the pawl-clutch elements axially retract, the clutch opens and no significant connection exists between hub-shaft 52 and the pulley body 40. Some amount of friction is desirable in the overrun condition and is provided by friction ring 70 (described above).

In the present invention, isolation, or damping, between rotation of the hub-shaft and the pulley body 40 is considered as angular displacement between input and output at a controlled, torsion rate with an amount of coulomb damping. The deflection of the isolator spring 72 translates to a torsion rate across the device. Coulomb damping is created by friction of the friction ring 70 sliding against the bore of the pulley body 40 or the second plate 64 during deflection of the isolator spring 72. Thus, the pulley body 40 and the hub-shaft 52 are decoupled, or isolated, from torsional excitations, generally of the pulley body 40. The isolator spring's spring rate can be varied to match system requirements. For example, the thickness of the spring or its coils, the tightness of the coil, the type of spring, the material it is made from can be varied. Moreover, the coulomb damping can be varied through selection of component materials, in particular the material of the friction ring 70, the pulley body 40, and/or the second plate 64 (at least the surface against which the friction ring 70 rubs.

Torque limiting input to the isolator spring is effected by the spring expanding, under load, to contact with the pulley body 40. At the instance of contact (the spring contacting the pulley body) additional torque is shunted to the pulley body 40; thus, protecting the isolator spring 72 from overstress and protecting its service life.

At rest there is no preload on the isolator spring 72. As discussed above, the spring 72 has one end 79 coupled to the pulley body 40 and the other end 78 coupled to one component of the clutch 60. Since the spring is coupled to the pulley body 40 with no preload, when the pulley body 40 rotates, the spring 72 rotates with the pulley body and as such rotates the component of the clutch 60 that the other end 78 of the spring is coupled to, first plate 62 as seen in FIG. 3. The first plate 62 will rotate with the spring 72 and pulley body 40 into an aligned position (illustrated in FIG. 5) with the second plate 64 that allows the strut 66 to engage the second plate 64 to the first plate 62 for rotation together in the positive direction, which will rotate the hub-shaft 52.

In the disclosed embodiments, all the throughput (positive) torque passes through the spring because one end of the spring 72 is coupled to the pulley body and the other end is coupled to one component of the one-way clutch, and the spring 72 is installed such that when loaded the spring will expand radially. When the spring expands radially it provides isolation and relative motion between the pulley body 40 and the hub-shaft 52 when the pulley is driving the hub-shaft and also isolates the system from the impact of stresses created by the clutch 60. The amount of stress on the spring is directly related to the amount of strain to which the spring is subject, and the amount of radial expansion thereof is directly related to the strain. If the radial expansion is constrained, then the strain, which is predominantly bending, becomes compressive. Thus, damage potential is mitigated.

The clutch 60, in particular the strut 66, remains in the engaged position (FIG. 5) until the spring unwinds to a zero or about zero torque (back to spring's rest (unloaded) position). Now, the second plate 64 can rotate independent of the pulley body 40, spring 72, and first plate 62 as an overrun motion. This overrun motion of the second plates 64 physically pushes the struts 66 into their retracted positions (FIG. 6) (non-engaged position) in the pockets 63 within the first plate 62, and the hub-shaft 52 rotates independently of the pulley body 40 under the laws of inertia until the hub-shaft 52 stops or the clutch re-engages and the hub-shaft 52 rotates with the pulley body 40 once again.

Various parameters can affect the operation, responsiveness, and performance of the pulley assemblies disclosed herein, including the angle of strut engagement, profile of the pockets and notches receiving the struts, the coefficients of friction between components in frictional engagement with one another, and the spring rate of the various isolator springs. Other factors that affect the selection of a particular combination include wear, primary clutching, durability and cost.

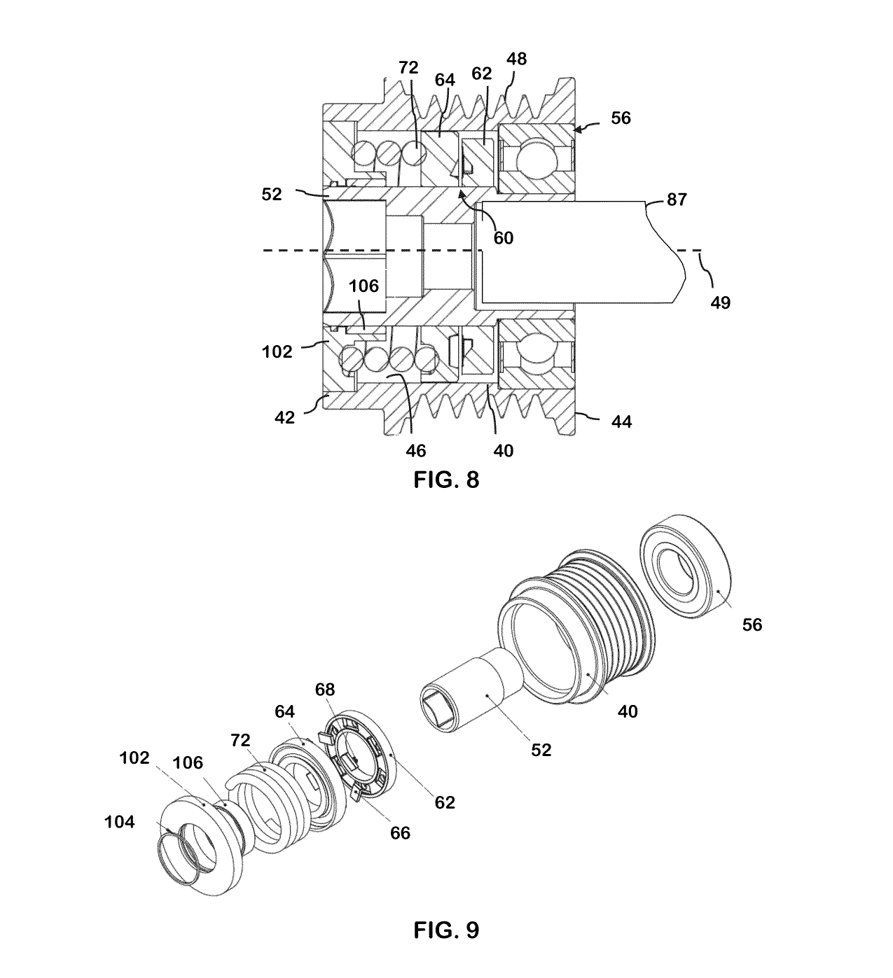

In an alternate embodiment illustrated in FIGS. 8 and 9, the one-way clutch mechanism 60 may be disposed nearer to the bearing 56, which places the isolator spring 72 outboard relative to the one-way clutch mechanism 60. In this embodiment, the pulley body 40 is generally similar to the description provided above and the components of the pulley assembly 16 moving from the first end 42 to the second end 44 may be an end cap 102 sealed by a sealing member 104 such as an 0-ring, the isolator spring 72, the one-way clutch mechanism 60, and then the bearing 56. In this embodiment, the friction ring is now ring 106 disposed between the end cap 102 and the hub-shaft 52 for frictional engagement when the pulley body 40 rotates relative to the hub-shaft 52. The embodiment of FIGS. 8 and 9 provide an alternate assembly process and an embodiment where the pulley assembly 16 can be filled with oil or light grease, which may also enable lower component cost. The pulley assembly 16 still operates generally the same as discussed above with the spring 72 providing isolation in conjunction with the coulomb damping provided by the friction ring 106.

In one aspect, the invention includes a pulley assembly for use in an automobile accessory drive system, the pulley assembly includes a hub defining an axis of rotation, a pulley body including a bore that receives the hub and has an outer peripheral belt-engaging surface, a one-way clutch mechanism comprising a mechanical diode construction that axially translates a strut to engage the clutch when the pulley rotates in a predominant direction, the engaged position having a component of the clutch mechanism engaged to the hub to link the hub to the pulley body for simultaneous rotation in the predominant direction. The pulley assembly includes an isolator spring operationally engaged at one end to the one-way clutch mechanism and at the other end to the pulley body.

The pulley assembly also includes frictional engagements between at least two components to provide damping. In one embodiment, damping is provided by a frictional engagement between a friction ring and the pulley body or second plate.

In a second aspect, the invention incudes a pulley assembly for use in an automobile accessory drive system, the pulley assembly includes a hub defining an axis of rotation, a pulley body including a bore that receives the hub and has an outer peripheral belt-engaging surface, a clutch actuator that includes a mechanical diode construction wherein at least one component thereof is axially translatable to engage a one-way clutch activatable by the rotation of the at least one other component of the clutch to engage a component of the clutch with the hub, and the engagement of the clutch mechanism with the hub links the hub to the pulley body for simultaneous rotation in a predominant direction.

In a third aspect, the invention includes a belt drive system that includes a belt entrained around a driving pulley, at least one accessory pulley, and, optionally, an idler pulley and/or a belt tensioner. In one embodiment, it is the accessory pulley that has one of configurations described above. Upon rotation of the pulley body in the non-dominant direction, such as under a torque reversal, the clutch disengages (the strut of the mechanical diode construction retracts axially in the opposite direction) so that the pulley body and hub rotate independently of one another, thereby permitting the shaft coupled to the hub to continue rotating with momentum in the predominate operational direction.

What is claimed is:

1. An assembly for selectively coupling torque between rotating components, the assembly comprising:
a rotatable input member and a rotatable output member;
a one-way clutch operatively connected to the rotatable input member and the rotatable output member to engage for rotation together the rotatable input member and the rotatable output member in a predominant direction; and
a spring having a first end engaged to the one-way clutch and having a second end engaged to the rotatable input member;
wherein the spring has no preload in an unengaged position of the one-way clutch and rotates with the rotatable input member during a positive torque condition to rotate a component of the one-way clutch to activate the one-way clutch into an engaged position;
wherein the spring, when the one-way clutch is in the engaged position, radially expands as the spring is loaded by the positive torque condition and thereby provides isolation between the rotatable input member and the rotatable output member.

2. The assembly of claim 1, wherein the input member includes a pulley body having a bore that has the output member received therein.

3. The assembly of claim 2, wherein the body includes an outer peripheral belt-engaging surface.

4. The assembly of claim 2, wherein the output member includes a hub defining the axis of rotation.

5. The assembly of claim 1, further comprising a friction ring disposed between the rotatable input member and the rotatable output member to provide coulomb damping.

6. The assembly of claim 1, wherein the one-way clutch comprises a mechanical diode construction that includes one or more struts.

7. An assembly for selectively coupling torque between rotating components, the assembly comprising:
a rotatable input member and a rotatable output member;
a one-way clutch operatively connected to the rotatable input member and the rotatable output member to engage for rotation together the rotatable input member and the rotatable output member in a predominant direction;
a friction ring disposed between the rotatable input member and the rotatable output member to provide coulomb damping; and
a spring having a first end engaged to the one-way clutch and having a second end engaged to the rotatable input member;
wherein the assembly provides isolation or damping between rotations of the rotatable input member and the rotatable output member at a torsion rate provided by the spring with an amount of coulomb damping provided by the friction ring.

8. The assembly of claim 7, wherein the one-way clutch comprises a mechanical diode construction that includes one or more struts.

9. The assembly of claim 7, wherein the input member includes a pulley body having a bore that has the output member received therein.

10. The assembly of claim 9, wherein the body includes an outer peripheral belt-engaging surface.

11. The assembly of claim 9, wherein the output member includes a hub defining the axis of rotation.

12. The assembly of claim 7, wherein the friction ring includes a friction-enhancing coating.

13. The assembly of claim 7, wherein the friction ring is mounted against the output member.

14. The assembly of claim 7, wherein the friction ring is mounted against the input member.

15. A belt drive system comprising:
an endless belt entrained about a driving pulley and at least one accessory pulley;
wherein the accessory pulley comprises:
a rotatable input member and a rotatable output member;
a one-way clutch operatively connected to the rotatable input member and the rotatable output member to engage for rotation together the rotatable input member and the rotatable output member in a predominant direction; and
a spring having a first end engaged to the one-way clutch and having a second end engaged to the rotatable input member;
wherein the spring has no preload in an unengaged position of the one-way clutch and rotates with the rotatable input member during a positive torque condition to rotate a component of the one-way clutch to activate the one-way clutch into an engaged position;
wherein the spring, when the one-way clutch is in the engaged position, radially expands as the spring is loaded by the positive torque condition and thereby provides isolation between the rotatable input member and the rotatable output member.
